(19) United States
(12) Patent Application Publication
(10) Pub. No.: US 2026/0139983 A1
(43) Pub. Date: May 21, 2026

(54) SOLAR POWERED APPARATUS AND A METHOD THEREOF

(71) Applicant: HONEYWELL INTERNATIONAL INC., Charlotte, NC (US)

(72) Inventors: Saravanan Nagasundaram, Hyderabad TS (IN); Murali Bezawada, Hyderabad TS (IN)

(21) Appl. No.: 19/390,003

(22) Filed: Nov. 14, 2025

(30) Foreign Application Priority Data
Nov. 21, 2024 (IN) 202411090608

(51) Int. Cl. G01F 15/14; G01F 15/063; G01F 15/18; H02J 7/34; H02J 7/35; H02S 20/20; H02S 40/38

(52) U.S. Cl. CPC G01F 15/14; G01F 15/063; G01F 15/185; H02J 7/345; H02J 7/35; H02S 20/20; H02S 40/38; H02J 2207/50

(57) ABSTRACT

An apparatus includes a body and a cover coupled to a portion of the body. The cover comprising a recess fabricated at a first side of the cover to accommodate at least one solar panel, wherein the at least one solar panel is configured to generate electrical energy and at least one circuit board positioned at a second side of the cover and electrically coupled to the at least one solar panel via at least one cable, the at least one circuit board is configured to receive the electrical energy from the at least one solar panel via the at least one cable and provide the received electrical energy to the apparatus.

### CROSS-REFERENCE TO RELATED APPLICATION

This application claims priority pursuant to 35 U.S.C. 119(a) to Indian Patent Office Application No. 202411090608, filed Nov. 21, 2024, which application is incorporated herein by reference in its entirety.

### TECHNOLOGICAL FIELD

Example embodiments of the present disclosure generally relate to a solar powered apparatus, and more particularly relates to a solar powered gas meter.

### BACKGROUND

Utility meters such as gas meters are powered with Non-rechargeable/Primary batteries. Whenever addition of new features in the gas meters is suggested, impact of the new features on the battery life becomes necessary. The new features include sending high resolution data on consumption, pressure, and temperature of gas to head end system (HES) which are required for improving gas grid performance or running edge analytics etc. These new features need to be carefully implemented while considering the battery life of gas meters.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, an apparatus is disclosed. The apparatus comprises a body and a cover coupled to a portion of the body. The cover comprises a recess fabricated at a first side of the cover and the recess is configured to accommodate at least one solar panel. The at least one solar panel is configured to generate electrical energy. The cover further comprises at least one circuit board positioned at a second side of the cover and electrically coupled to the at least one solar panel via at least one cable. The at least one circuit board is configured to receive the electrical energy from the at least one solar panel via the at least one cable and provide the received electrical energy to the apparatus.

In some embodiments, the portion corresponds to at least one of a front portion, a side portion, a top portion, or a bottom portion of the body. In some embodiments, the first side is opposite to the second side of the cover. The first side of the cover corresponds to an outer side and the second side of the cover corresponds to an inner side.

In some embodiments, the at least one circuit board is configured to be screwed or snap-fitted to the inner side of the cover based at least on depth of the inner side of the cover. In some embodiments, the at least one solar panel is positioned within the recess via an adhesive. In some embodiments, the adhesive is configured to provide ingress protection (IP) to the at least one solar panel.

In some embodiments, the at least one cable is passing from the first side to the second side of the cover via an aperture. In some embodiments, at least one end of the at least one cable is coupled with a snap-on connector that is configured to electrically connect the at least one solar panel and the at least one circuit board with an electrical source. In some embodiments, the cover is detachable from the body and replaceable.

In some embodiments, the at least one circuit board is electrically coupled to a rechargeable battery or to a super capacitor positioned within the apparatus to recharge the rechargeable battery or to recharge the super capacitor via the received electrical energy.

In some embodiments, the first side of the cover is configured to have a tilted surface, the tilted surface is configured to provide solar coverage to the at least one solar panel.

In some embodiments, the at least one circuit board may server as the main circuit board, which may include an LCD, a wireless communication circuit, and a measurement circuit assembled.

In some embodiments, the first side of the cover comprises at least one button. The at least one button is configured to scroll and select between one or more parameters of readings of the apparatus.

In another example embodiment, a method is disclosed. The method comprises the steps of coupling a cover to a portion of a body. The cover comprises a recess fabricated at the first side of the cover, wherein the recess is configured to accommodate at least one solar panel, and wherein the at least one solar panel is configured to generate electrical energy. Further, the cover comprises at least one circuit board positioned at a second side of the cover and electrically coupled to the at least one solar panel via at least one cable, wherein the at least one circuit board is configured to receive the electrical energy from the at least one solar panel via the at least one cable and provide the received electrical energy to the apparatus.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a perspective view of an apparatus in accordance with an example embodiment of the present disclosure;

FIG. 2 illustrates an exploded view of a cover of the apparatus in accordance with an example embodiment of the present disclosure;

FIGS. 3A-3B illustrate an exploded view of the apparatus in accordance with an example embodiment of the present disclosure;

FIG. 4 illustrates a perspective view of the apparatus installed on a utility meter in accordance with an example embodiment of the present disclosure;

FIGS. 5A-5B illustrate tables showing specifications of at least one solar panel in accordance with an example embodiment of the present disclosure;

FIG. 6A illustrates a table showing measurement data of the at least one solar panel during different time of sunny weather in accordance with an example embodiment of the present disclosure;

FIG. 6B illustrates a table showing measurement data of the at least one solar panel during different time of cloudy weather in accordance with an example embodiment of the present disclosure;

FIG. 6C illustrates a table showing measurement data of the at least one solar panel during sunny weather and cloudy weather in accordance with an example embodiment of the present disclosure;

FIG. 7 illustrates a graph showing intensity of sunlight with respect to time and weather conditions in accordance with an example embodiment of the present disclosure;

FIG. 8 illustrates a graph showing current measurements of the at least one solar panel with respect to time and weather conditions in accordance with an example embodiment of the present disclosure;

FIG. 9A illustrates a perspective view of an apparatus in accordance with a first alternate embodiment of the present disclosure;

FIG. 9B illustrates a perspective view of an apparatus in accordance with a second alternate embodiment of the present disclosure;

FIG. 9C illustrates a perspective view of the apparatus in accordance with a third alternate embodiment of the present disclosure;

FIG. 9D illustrates a perspective view of the apparatus in accordance with a fourth alternate embodiment of the present disclosure;

FIG. 10A illustrates a perspective view of the apparatus installed on a utility meter in accordance with the first alternate embodiment of the present disclosure; and,

FIG. 10B illustrates a perspective view of the apparatus installed on a utility meter in accordance with the second alternate embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of an apparatus. Embodiments may comprise a body and a cover coupled to the body. The body may comprise a recess fabricated on the cover. Embodiments may be configured to accommodate at least one solar panel that is configured to generate electrical energy. The cover may comprise at least one circuit board coupled to the at least one solar panel. Embodiments may be configured to receive the electrical energy from the at least one solar panel and provide the received electrical energy to the apparatus.

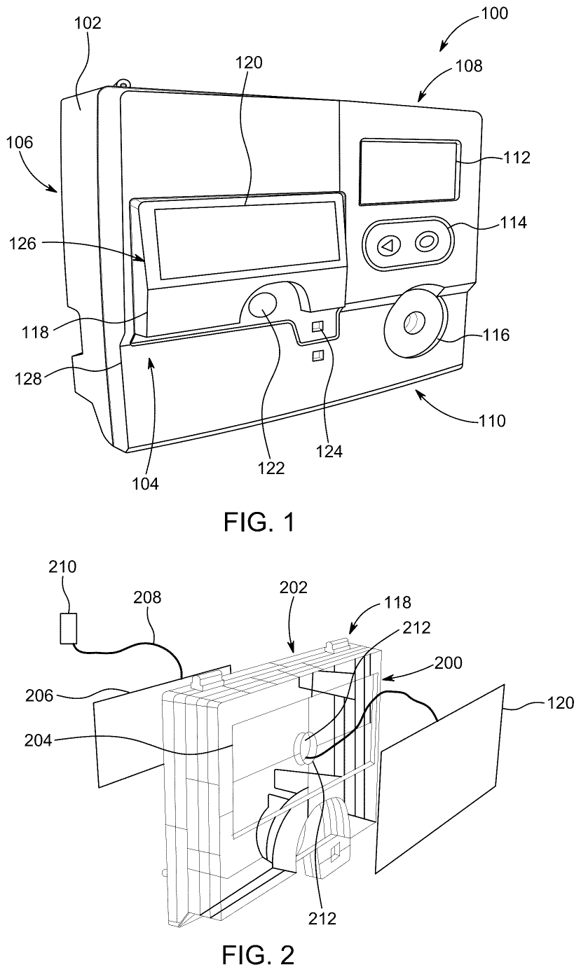

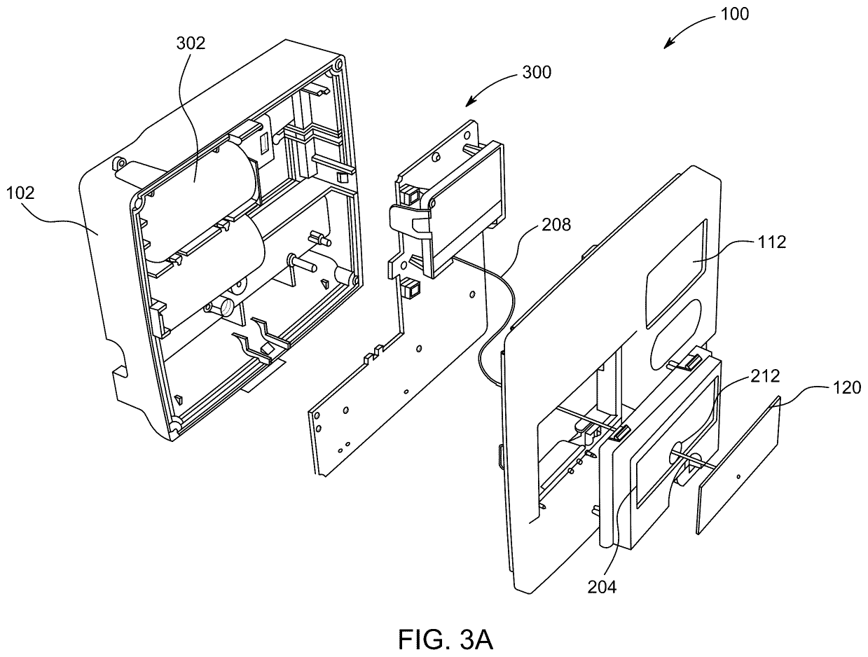

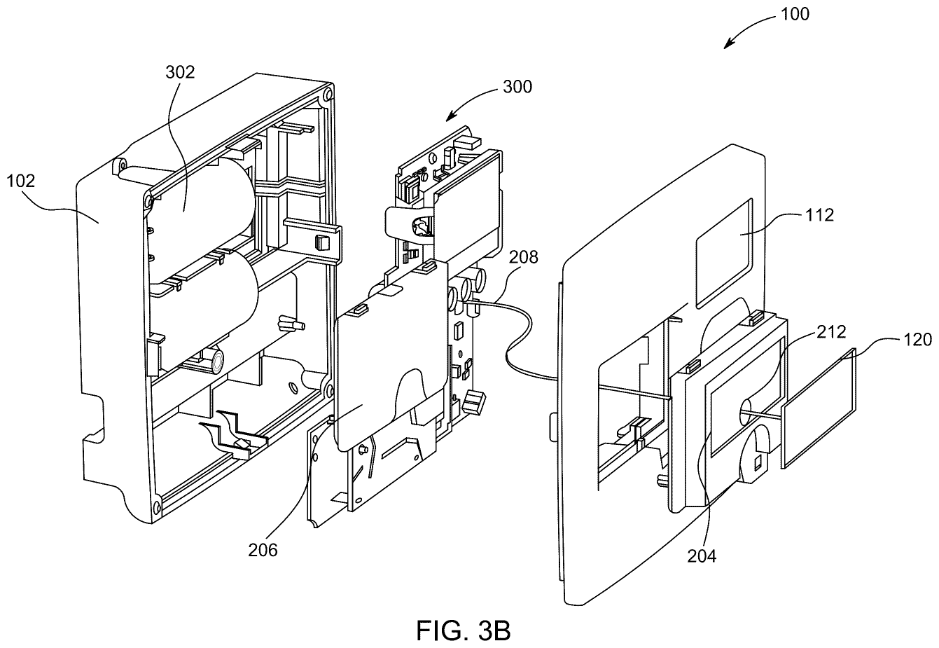

FIG. 1 illustrates a perspective view of an apparatus 100, in accordance with an example embodiment of the present disclosure. FIG. 2 illustrates an exploded view of a cover 118 of the apparatus 100, in accordance with an example embodiment of the present disclosure. FIGS. 3A-3B illustrate an exploded view of the apparatus 100, in accordance with an example embodiment of the present disclosure.

In some embodiments, the apparatus 100 may comprise a body 102. The body 102 may comprise a front portion 104, a side portion 106, a top portion 108, or a bottom portion 110. In an example, the apparatus 100 may be a gas meter index. The gas meter index may be a numerical display installed on the utility meter. In some embodiments, the apparatus 100 may correspond to the gas meter index, however in various embodiments other types of meter indices may be used. In some embodiments the other types of meter indices may comprise at least an electricity meter index, a water meter index etc. In some embodiments, the front portion 104 of the body may further comprise a display panel 112 to display one or more parameters of the apparatus 100. The one or more parameters may include battery status, gas consumption etc. In some embodiments, the front portion 104 of the body may further comprise a set of buttons 114 to operate the display panel 112. Further, the body 102 may comprise optical communication port 116 to locally communicate with the utility meter.

In some embodiments, the apparatus 100 may comprise the cover 118 coupled to the portion of the body. The portion may correspond to the front portion 104, the side portion 106, the top portion 108, or the bottom portion 110 of the body 102. The cover 118 may further comprise a first side 200 and a second side 202 such that the first side 200 is opposite to the second side 202 (shown in FIG. 2). The first side 200 may correspond to an outer side of the cover 118 and the second side 202 may correspond to an inner side of the cover 118. In some embodiments, the first side 200 may be further fabricated with at least one hole 124. The at least one hole 124 may be configured to couple the cover 118 to a section 128 of the body 102. In an example, the front side may be fabricated with the at least one hole 124 to couple the cover 118 to the body. In an example, the at least one hole 124 may be configured to couple the cover 118 to the at least one of the front portion 104, the side portion 106, the top portion 108, or the bottom portion 110 of the body 102.

In some embodiments, the first side 200 (outer side) of the cover 118 may comprise a recess 204. In some embodiments, the recess 204 may be fabricated in a shape complementary to the shape of at least one solar panel 120. The recess 204 may be configured to accommodate the at least one solar panel 120. In some embodiments, the at least one solar panel 120 may be positioned within the recess 204 via an adhesive. In one example, the adhesive may be at least one of silicon adhesive, polyurethane adhesive, epoxy adhesive, acrylic adhesive or butyl rubber adhesive. In some embodiments, the adhesive may be configured to provide ingress protection (IP) to the at least one solar panel 120. In an example, the ingress protection may correspond to securing the at least one solar panel 120 via the adhesive such that the adhesive may prevent the at least one solar panel 120 from water, dust and other environmental factors.

In some embodiments, the at least one solar panel 120 may be configured to generate electrical energy. In some embodiments, the at least one solar panel 120 may be a photovoltaic panel enabled to convert sunlight directly into electrical energy. In an example, the at least one solar panel 120 may comprise a plurality of solar cells. The plurality of solar cells may be composed of semiconductor material. In an example, the at least one solar panel 120 when exposed to direct sunlight, the direct sunlight may excite electrons of the semiconductor material to generate electrical energy.

In some embodiments, the first side 200 of the cover 118 may have a tilted surface 126. The tilted surface 126 may be configured to provide better solar coverage to the at least one solar panel 120. In one example, the front side 200 of the cover 118 may have the titled surface 126 to achieve maximum surface area of the at least one solar panel 120 exposed to the sunlight. In some embodiments, the cover 118 may be configured to be detachable from the body 102 and may be replaceable from the body 102.

In some embodiments, at least one circuit board 206 may be positioned at the second side 202 of the cover 118. In an example, the at least one circuit board 206 may be positioned at the inner side of the cover 118. In some embodiments, the at least one circuit board 206 may be screwed or snap-fitted to the inner side of the cover 118 based at least on depth of the inner side of the cover 118. In an example, the at least one circuit board 206 may be screwed to the inner side of the cover 118 by means of a screw. The screw may thread into a preformed hole or a nut at the inner side of the cover 118. In some embodiments, the at least one circuit board 206 may be screwed to the inner side of the cover 118 in an instance when the depth of the inner side of the cover 118 may be significant.

In another example, the at least one circuit board 206 may be snap fitted to the inner side of the cover 118. The at least one circuit board 206 may be fitted to the inner side of the cover 118 by means of interlocking tabs. For example, at least one tab mounted to the at least one circuit board 206 may be interlocked with another tab mounted to the inner side of the cover 118. In some embodiments, the at least one circuit board 206 may be snap fitted to the inner side of the cover 118 when the depth of the inner side of the cover 118 may be less or not significant enough to accommodate the screw. In one example embodiments, a main circuit board 300 (shown in FIGS. 3A-3B) is configured to receive electrical energy directly from at least one solar panel 120 via the at least one cable 208 and deliver this electrical energy to the apparatus 100 (to enable functioning of the apparatus 100) without requiring the at least one circuit board 206.

In some embodiments, the at least one circuit board 206 may be coupled to the at least one solar panel 120 via at least one cable 208. In some embodiments, the at least one cable 208 may be arranged in a manner that the at least one cable 208 passes from the first side 200 to the second side 202 of the cover 118 via an aperture 212. In an example, the at least one cable 208 may pass from the outer side of the cover 118 to the inner side of the cover 118 via the aperture 212. In some embodiments, the at least one circuit board 206 may serve as a main circuit board 300 and include components or circuits such as an LCD, a wireless communication circuit, a rechargeable battery, a supercapacitor and a measurement circuit.

In some embodiments, at least one end of the at least one cable 208 may be coupled with a snap-on connector 210. In an example, the snap-on connector 210 may include at least one tab enabled to be fit with at least one female counterpart tab via snap action. In some embodiments, the snap-on connector 210 may electrically connect the at least one solar panel 120 and the at least one circuit board 206 with an electrical source or the apparatus 100. In an example, the at least one tab may be mounted to the at least one end of the at least one cable 208 and the at least one female counterpart tab may be mounted to the electrical source. The snap fit coupling between the at least one tab and the at least one female counterpart tab may electrically connect the at least one solar panel 120 and the at least one circuit board 206 with the electrical source.

In some embodiments, the at least one cable 208 is passing from the first side 200 to the second side 202 of the cover 118 via an aperture 212. At least one end of the at least one cable 208 is coupled with a snap-on connector that is configured to electrically connect the at least one solar panel 120 and the at least one circuit board 206 with a charging circuit and a rechargeable battery or a non-rechargeable battery 302 or a super capacitor to recharge the rechargeable battery or recharge the super capacitor via the received electrical energy.

In some embodiments, the at least one circuit board 206 may be electrically coupled to a rechargeable battery or to the non-rechargeable battery 302 or the super capacitor positioned within the apparatus 100. The apparatus 100 may be powered by the rechargeable battery to perform one or more functions. In some embodiments, the at least one solar panel 120 is configured to use the sunlight and generate electrical energy. The electrical energy may be received by the at least one circuit board 206 via the at least one cable 208. In some embodiments, the electrical energy may be stored in the rechargeable battery or in the super capacitor.

In some embodiments, the main circuit board 300 may be electrically coupled to a rechargeable battery or the non-rechargeable battery 302 or to the super capacitor positioned within the apparatus 100. The apparatus 100 may be powered by the rechargeable battery to perform one or more functions. In some embodiments, the at least one solar panel 120 is configured to use the sunlight and generate electrical energy. The electrical energy may be received by the main circuit board 300 via the at least one cable 208. In some embodiments, the electrical energy may be stored in the rechargeable battery or in the super capacitor.

In some embodiments, the first side 200 (the outer side) of the cover 118 may comprise at least one button 122. In some embodiments, the at least one button 122 is configured to scroll between one or more parameters of readings of the apparatus 100. Further, the at least one button 122 is configured to select between the one or more parameters. In some embodiments, the one or more parameters comprise measurement units, parameters etc. In some embodiments, the measurement units may comprise cubic meter (m³) to cubic feet (ft³) and the parameters may comprise volume of gas, pressure of gas, temperature etc. In one example, the at least one button 122 is used to change measurement units from cubic meter (m³) to cubic feet (ft³) in a gas meter index. In some embodiments, the at least one button 122 is further configured to activate or deactivate the display panel 112. In another example embodiment, the meter main circuit board 300 is configured to receive electrical energy directly from at least one solar panel 120 via the at least one cable 208 and deliver this energy to the apparatus 100 without requiring any extra circuit board on the second side of the cover 118.

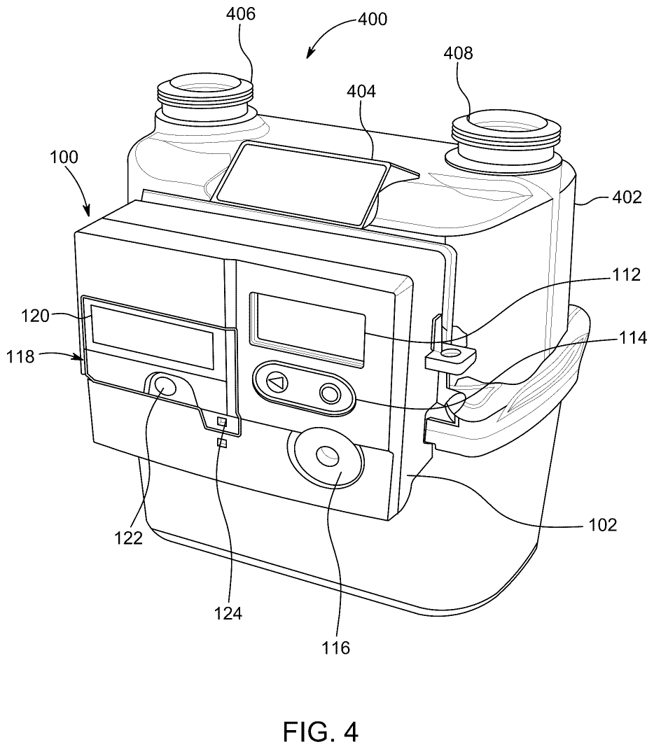

FIG. 4 illustrates a perspective view of the apparatus 100 installed on a utility meter 400, in accordance with an example embodiment of the present disclosure.

In some embodiments, the apparatus 100 may include the body 102. The apparatus 100 may be the gas meter index. The gas meter index may be installed on the utility meter 400(e.g., a gas meter). In an example, the utility meter 400 may be the gas meter. The gas meter is used to measure volume of gas consumed by a residential or commercial building. The gas meter may include a meter body 402, a name plate 404 and a set of inlet port 406 and outlet port 408. The gas meter records amount of gas passing through the set of inlet port 406 and outlet port 408 and displays recorded value on the display panel 112.

In some embodiments, the apparatus 100 may include the cover 118 coupled to the first portion 104 of the body 102. In some embodiments, the cover 118 may be coupled to the at least one of the front portion 104, the side portion 106, the top portion 108 or the bottom portion 110 of the gas meter index. In an example, the cover 118 may be coupled to the front portion 104 of the gas meter index.

In some embodiments, the cover 118 may comprise the recess 204 to accommodate the at least one solar panel 120. The recess 204 may be fabricated at the first side 200 (outer side) of the cover 118. In an example the at least one solar panel 120 may be exposed to weather conditions of location where the gas meter may be installed. In some embodiments, the solar panel 120 may include the plurality of photovoltaic cells that convert solar energy to electrical energy. In an example, the solar energy may be derived from sunlight when the at least one solar panel 120 is exposed to sunlight during sunny weather. Upon deriving the solar energy from the sunlight, the at least one solar panel 120 may generate electrical energy.

In some embodiments, the apparatus 100 may comprise the at least one circuit board 206. In an example, the gas meter index may include the at least one circuit board 206 positioned at the second side 202 (inner side) of the cover 118. In some embodiments, the at least one circuit board 206 may be coupled to the at least one solar panel 120 via the at least one cable 208. In some embodiments, the cover 118 may include the aperture 212. In some embodiments, the at least one cable 208 may pass from the first side 200 (outer side) of the cover 118 to the second side 202 (inner side) of the cover 118 through the aperture 212.

In some embodiments, the utility meter 400 may comprise one or more sensors for measuring flow of gas within the utility meter 400. In some embodiments, the one or more sensors may be powered by the electrical energy generated by the apparatus 100. The apparatus may be configured to send the electrical energy to the battery that may send the electrical power to the one or more sensors.

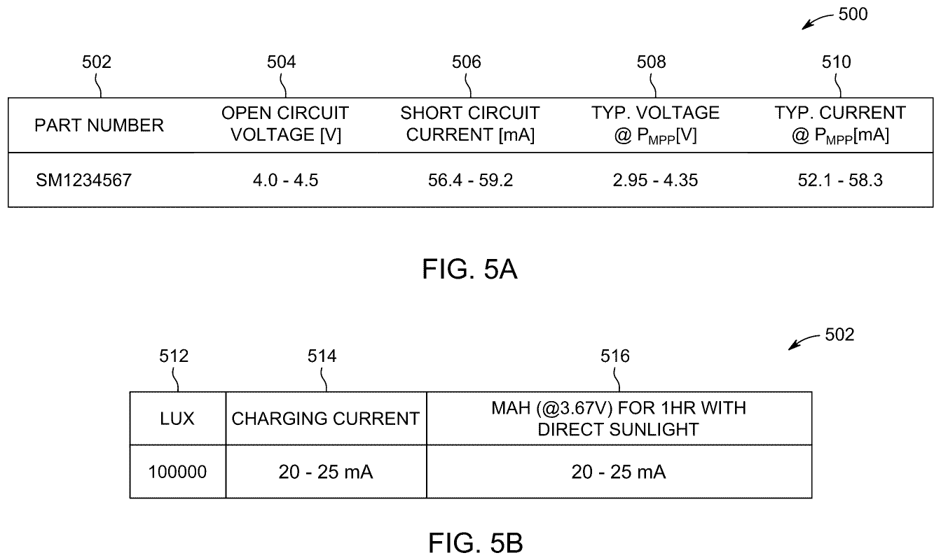

FIGS. 5A-5B illustrate tables 500, 502 showing specifications of at least one solar panel 120, in accordance with an example embodiment of the present disclosure.

In some embodiments, the apparatus 100 may include the cover 118 having the recess 204. The recess 204 may accommodate the at least one solar panel 120. In an example, the recess 204 may accommodate the at least one solar panel 120 such that the at least one solar panel 120 may be exposed to sunlight in sunny weather conditions. The at least one solar panel 120 may be configured to covert solar energy from the sunlight to the electrical energy. In an example, specifications of the solar panel 120 may be shown in the table 500.

As illustrated in FIG. 5A, in an example, the specifications may include unique identifier or model number (part number) 502, open circuit voltage (V) 504, short circuit current (mA) 506, typical voltage (P_{MPP}[V]) 508 and typical current (P_{MPP}[mA]) 510. The open circuit voltage (V) 504 may correspond to maximum voltage the at least one solar panel 120 may produce when the at least one solar panel 120 is not connected to any load (i.e., when circuit is open). The short circuit current (mA) 506 may correspond to the current flowing when terminals of the at least one solar panel 120 may be shorted, i.e., zero resistance. The typical voltage (P_{MPP}[V]) 508 may correspond to maximum power point (MPP), the voltage at which the at least one solar panel 120 produces maximum electrical energy. The typical current (P_{MPP}[mA]) 510 may correspond to typical current at the MPP, current at which the at least one solar panel 120 produces maximum electrical energy.

In one example, the part number may be SM1234567, the open circuit voltage (in the range of 4.0-4.5 Volts) 504 and the short circuit current (in the range of 56.4-59.2 mA) 506 suggest upper limits of voltage and current for operating conditions of the at least one solar panel 120. The typical voltage (in the range of 2.95-4.35 Volts) 508 and the typical current 510 (in the range of 52.1-58.3 mA) suggest values of voltage and current that enable the at least one solar panel 120 produce maximum electrical energy.

As illustrated in FIG. 5B, the table 502 corresponds to charging performance of the at least one solar panel 120 under specific lighting conditions. In some embodiments, the charging performance may be dependent on one or more specifications including intensity of light (LUX) 512, charging current 514 and amount of charge the rechargeable battery may store in one hour of direct sunlight 516. The amount of charge the rechargeable battery may store in one hour of direct sunlight may further account for efficiency of the at least one circuit board 206 and losses. In an example, higher the intensity of light (LUX) 512 may correspond to brighter light. In an example, the light may correspond to sunlight in sunny weather conditions, when the apparatus 100 may be exposed to the sunlight.

In an example, the intensity of light (LUX) 512 of value 100000 may be very bright light similar to direct sunlight. When the apparatus 100 may be installed in the gas meter assembled in a pipeline and exposed to sunlight in sunny weather conditions, the at least one solar panel 120 (of similar specifications as shown in FIG. 5A) may generate charging current 514 of 23mA. Further, upon being exposed to the sunlight of 100000 LUX for an hour, the at least one solar panel 120 may charge the rechargeable battery amount of charge i.e., the rechargeable battery may store in one hour of direct sunlight 516 is 23 mA of charge considering the voltage of 3.67V. In an example, the 23m A of charge may account for losses due to charge to electrical energy conversion.

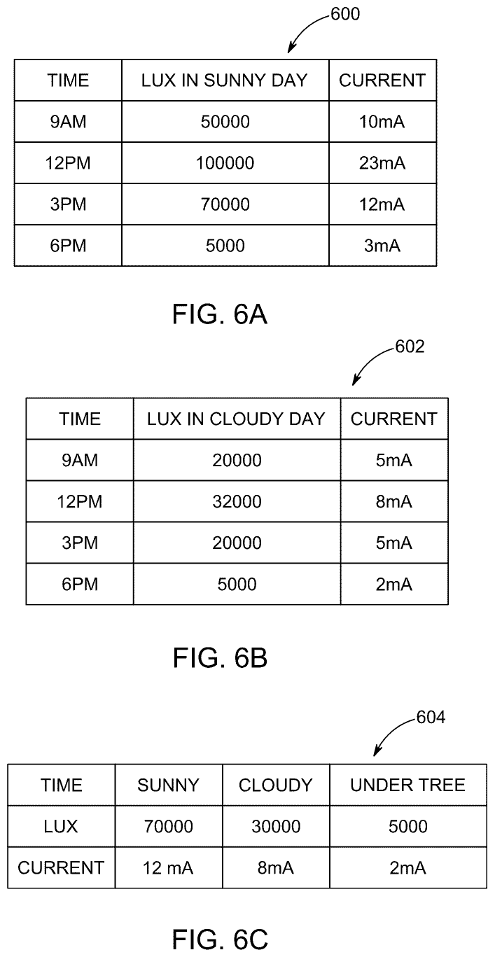

FIG. 6A illustrates a table 600 showing measurement data of the at least one solar panel during different time of sunny weather, in accordance with an example embodiment of the present disclosure. FIG. 6B illustrates a table 602 showing measurement data of the at least one solar panel during different time of cloudy weather, in accordance with an example embodiment of the present disclosure. FIG. 6C illustrates a table 604 showing measurement data of the at least one solar panel during sunny weather and cloudy weather, in accordance with an example embodiment of the present disclosure.

In an example, the apparatus 100 may be installed on a gas meter. The at least one cable 208 may electrically connect the at least one solar panel 120 and the at least one circuit board 206 with the rechargeable battery or with the super capacitor of the gas meter. In an example, the at least one cable 208 may be used to install the apparatus 100 in the gas meter by connecting the at least one solar panel 120 and the at least one circuit board 206 with the rechargeable battery of the gas meter using the snap-on connector 210. Further, the gas meter may be installed in a gas pipeline exposed to the weather conditions. In an example, weather conditions may correspond to sunny or cloudy weather. In an example, an ammeter may be electrically connected to the at least one solar panel 120 to record the current generated by the at least one solar panel 120 and the recorded values of the current are shown in FIGS. 6A-6C.

As illustrated in the table 600 of FIG. 6A, in an example, during a day with sunny weather at 9 AM (morning), the intensity of sunlight may be 50000 LUX. Accordingly, during the sunny weather at 9 AM, the at least one solar panel 120 may generate 10 mA of current. Further, in same weather at 12 pm (noon), when the intensity of sunlight may be highest e.g., 100000 LUX, the at least one solar panel 120 may generate the highest amount of current e.g., 23 mA. Further, during the afternoon at 3 pm of the same day with same weather, the intensity of sunlight may be 70000 LUX and the at least one solar panel 120 may generate the current of 12 mA. Further, during the evening at 6 pm of the same day with same weather, the intensity of sunlight may be minimum e.g., 5000 LUX, and the at least one solar panel 120 may generate the current of 3 mA.

As illustrated in the table 602 of FIG. 6B, in an example, during a day with cloudy weather at 9 AM (morning), the intensity of sunlight may be 20000 LUX. Accordingly, during the cloudy weather at 9 AM, the at least one solar panel 120 may generate 5 mA of current. Further, in same weather at 12 PM (noon), when the intensity of sunlight may be highest e.g., 32000 LUX, the at least one solar panel 120 may generate the highest amount of current e.g., 8 mA. Further, during the afternoon at 3 PM of the same day with same weather, the intensity of sunlight may be 20000 LUX and the at least one solar panel 120 may generate the current of 5 mA. Further, during the evening at 6 PM of the same day with same weather, the intensity of sunlight may be minimum e.g., 5000 LUX, and the at least one solar panel 120 may generate the current of 2 mA.

In an example, the amount of current generated by the at least one solar panel 120 may be directly proportional to the intensity of sunlight. During morning time, when the intensity of sunlight may be less, the at least one solar panel 120 may generate less current. During afternoon time, when the intensity of sunlight may be highest, the at least one solar panel 120 may generate maximum current. During evening time when the intensity of sunlight may be least, the at least one solar panel 120 may generate minimum current. Further, in an example, the at least one solar panel 120 may generate more current in sunny weather as compared to the cloudy weather.

In an example, the at least one solar panel 120 installed on the gas meter may be lying under a tree. In an example, the gas pipeline wherein the gas meter may be installed may lie under the tree. As illustrated in the table 604 of FIG. 6C, the intensity of sunlight reaching the at least one solar panel 120 (under the tree) may be less as compared to the intensity of sunlight reaching the at least one solar panel 120 completely exposed to sun. In an example, the intensity of sunlight reaching the at least one solar panel 120 (under the tree) may be 5000 LUX, and accordingly, the at least one solar panel 120 may generate current of 2 mA which is lower than the current generated by the at least one solar panel 120 during the sunny day (12 mA at 70000 LUX) and the cloudy day (8 mA at 30000 LUX).

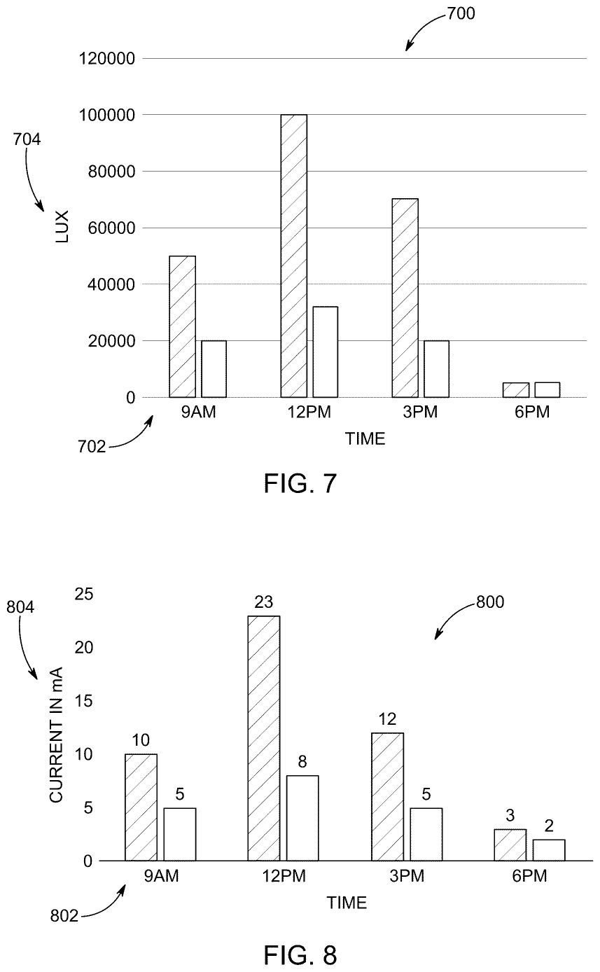

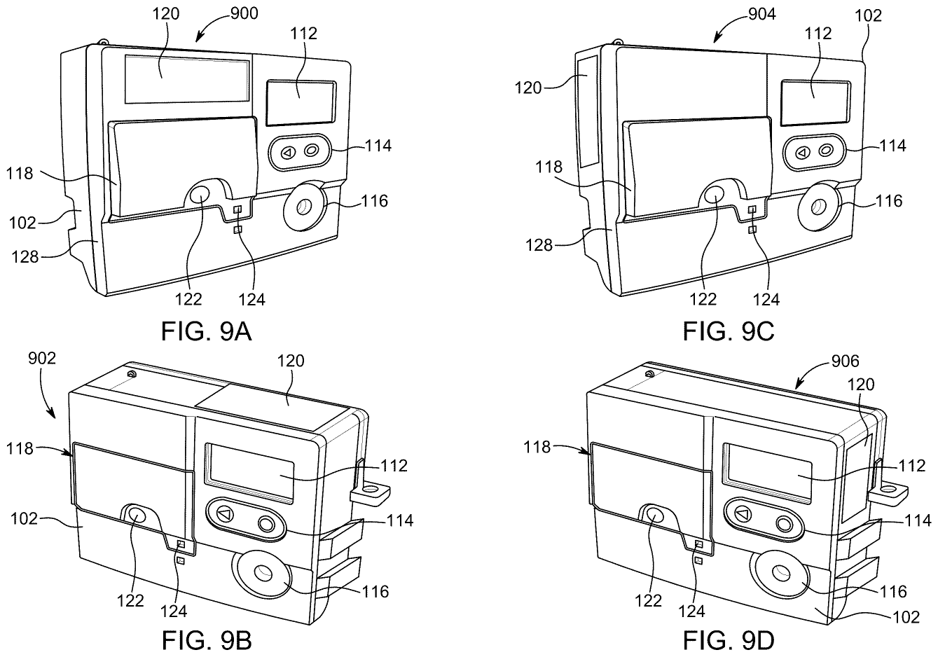

FIG. 7 illustrates a graph 700 showing intensity of sunlight with respect to time and weather conditions, in accordance with an example embodiment of the present disclosure FIG. 8 illustrates a graph 800 showing current measurements of the at least one solar panel with respect to time and weather conditions, in accordance with an example embodiment of the present disclosure.

In an example, the apparatus 100 may be installed on a water meter. The at least one cable 208 may electrically connect the at least one solar panel 120 and the at least one circuit board 206 with the rechargeable battery of the water meter. In an example, the at least one cable 208 may be used to install the apparatus 100 in the water meter by connecting the at least one solar panel 120 and the at least one circuit board 206 with the rechargeable battery of the water meter using the snap-on connector 210. Further, the water meter may be installed in a water pipeline exposed to the weather conditions. In an example, weather conditions may correspond to sunny or cloudy weather. In an example, an ammeter may be electrically connected to the at least one solar panel 120 to record the current generated by the at least one solar panel 120 and the recorded values of the current. Further, a lux meter may be placed close to the water meter to record the intensity of sunlight. The recorded values of the intensity of sunlight and the recorded values of the current are plotted against time, as shown in FIGS. 7-8.

As illustrated in the graph 700 of FIG. 7, the recorded values of intensity of sunlight are plotted against time. The values of time are plotted against an X-axis 702 and values of the intensity of sunlight (LUX) plotted against a Y-axis 704. The shaded bars of the graph 700 correspond to intensity of sunlight recorded during the sunny day and the clear bars of the graph 700 correspond to intensity of sunlight recorded during the cloudy day. In an example, at 9 AM, the intensity of sunlight may be more (50000 LUX) during the sunny day as compared to the intensity of sunlight (20000 LUX) during the cloudy day. Further, the intensity of sunlight (100000 LUX) may be maximum at 12 noon of the sunny day as compared to the morning and evening of the sunny day. Similarly, the intensity of sunlight (30000 LUX) may be maximum at 12 noon of the cloudy day as compared to the morning and evening of the cloudy day. Further the intensity of sunlight (5000 LUX) may be minimum during evening (6 PM) of both the sunny day and the cloudy day.

As illustrated in graph 800 of FIG. 8, the recorded values of current generated by the at least one solar panel 120 are plotted against time. The values of time are plotted against the X-axis 802 and values of the current (mA) plotted against the Y-axis 804. The shaded bars of the graph 800 correspond to the current generated by the at least one solar panel 120 during the sunny day and the clear bars of the graph 800 correspond to the current generated by the at least one solar panel 120 during the cloudy day. In an example, at 9 AM, the current generated by the at least one solar panel 120 may be more (e.g., 10 mA current) during the sunny day as compared to the current (e.g., 5 mA current) generated by the at least one solar panel 120 during the cloudy day. Further, the current (23 mA) generated by the at least one solar panel 120 may be maximum at 12 noon of the sunny day as compared to the morning and evening of the sunny day. Similarly, the current (8 mA) generated by the at least one solar panel 120 may be maximum at 12 noon of the cloudy day as compared to the morning and evening of the cloudy day. Further, the current (3 mA, 2 mA) generated by the at least one solar panel 120 may be minimum during evening (6pm) of both the sunny day and the cloudy day.

In an example, the amount of current generated by the at least one panel 120 may be directly proportional to the intensity of sunlight. Further, the intensity of sunlight may be maximum during noon time and less during the morning and evening time. Further, the intensity of sunlight may be less during the sunny day as compared to the cloudy day. Accordingly, the amount of current generated by the at least one solar panel 120 may be maximum during noon time and less during the morning and evening time. Further, the amount of current generated by the at least one solar panel 120 may be less during the sunny day as compared to the cloudy day.

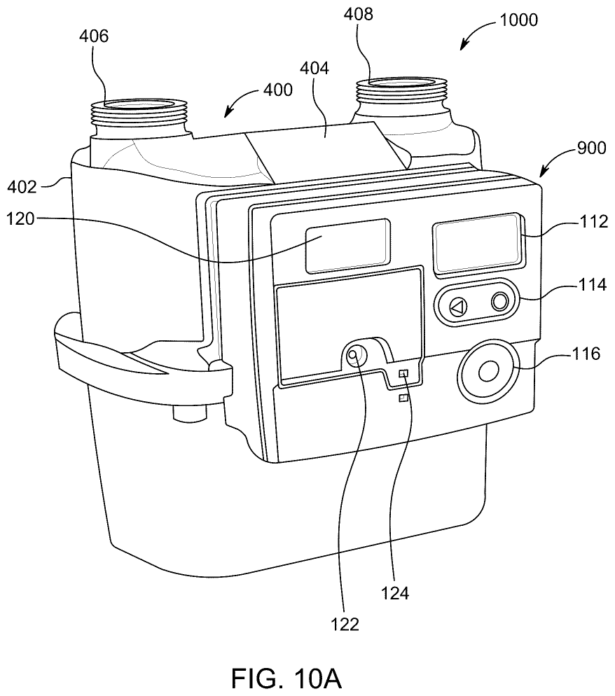

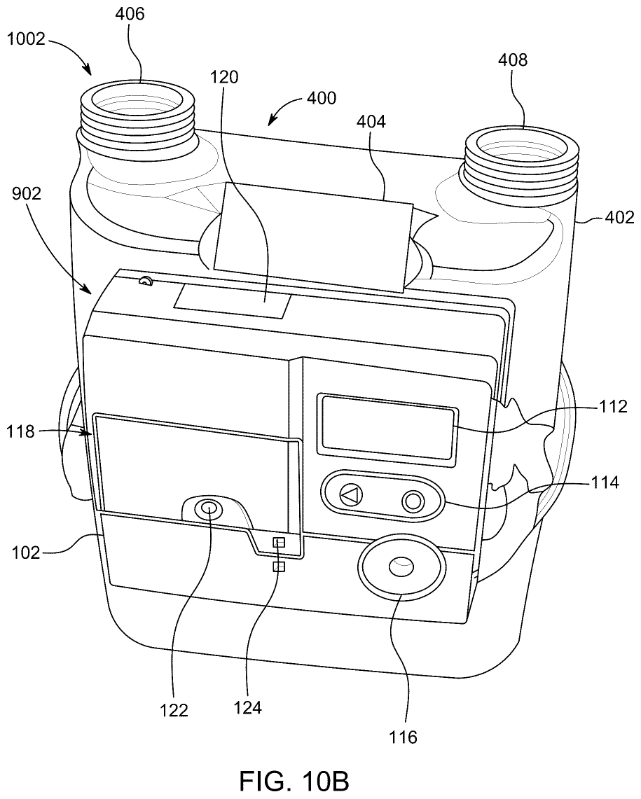

FIG. 9A illustrates a perspective view of an apparatus 900, in accordance with a first alternate embodiment of the present disclosure. FIG. 9B illustrates a perspective view of an apparatus 902, in accordance with a second alternate embodiment of the present disclosure. FIG. 9C illustrates a perspective view of the apparatus 904, in accordance with a third alternate embodiment of the present disclosure. FIG. 9D illustrates a perspective view of the apparatus 906, in accordance with a fourth alternate embodiment of the present disclosure. FIG. 10A illustrate a perspective view of the apparatus 900 installed on a utility meter 1000, in accordance with the first alternate embodiment of the present disclosure and FIG. 10B illustrate a perspective view of the apparatus 902 installed on the utility meter 1002, in accordance with the second alternate embodiment of the present disclosure.

In an alternate embodiment, the apparatus 900 may comprise the body 102 and the cover 118. The cover 118 may be coupled to at least the front portion 104, the side portion 106, the top portion 108 or the bottom portion 110 of the body 102. In an example the apparatus 100 may be the gas meter index. The gas meter index may be installed on the utility meter 1000 (example gas meter). The gas meter index may comprise the display panel 112, the set of buttons 114 along with the optical communication port 116. The display panel 112 may indicate measurement values and the set of buttons 114 may be configured to set one or more features of the utility meter 1000 or the gas meter index. Further, the optical communication port 116 may be used to connect the front portion 104 with the back portion (not shown) of the body 102.

In some embodiments, the cover 118 may be fabricated with at least one hole 124 to couple the cover 118 to at least the front portion 104, the side portion 106, the top portion 108 or the bottom portion 110 of the body 102. In the first alternative embodiment, the at least one solar panel 120 may be coupled to the front portion 104 of the body. In an example, the at least one solar panel 120 may be coupled to the front portion 104 of the body 102, above the cover 118 (as shown in FIG. 9A). In the second alternative embodiment, the at least one solar panel 120 may be coupled to the top portion 108 of the body 102. In an example, the at least one solar panel 120 may be coupled to the top portion 108 of the body 102, above the display panel 112 (as shown in FIG. 9B). In the third alternative embodiment, the at least one solar panel 120 may be coupled to the side portion 106 of the body 102. In an example, the at least one solar panel 120 may be coupled to a left side portion of the body 102, close to the cover 118 (as shown in FIG. 9C). In another example, the at least one solar panel 120 may be coupled to a right side portion of the body 102, close to the display panel 112 (as shown in FIG. 9D). The at least one solar panel 120 may be configured to convert solar energy from sunlight into electrical energy.

In some embodiments, the body 102 may comprise the at least one circuit board 206 electrically coupled to the at least one solar panel 120 through the at least one cable 208. The at least one circuit board 206 may receive the electrical energy from the at least one solar panel 120 via the at least one cable 208 and provide the received electrical energy to the apparatus 800 of FIG. 9A. Similarly, the at least one circuit board 206 may receive the electrical energy from the at least one solar panel 120 via the at least one cable 208 and provide the received electrical energy to the apparatus 902 of FIG. 9B, the apparatus 904 of FIG. 9C and apparatus 906 of FIG. 9D. Further, the at least one circuit board 206 may be electrically coupled to a rechargeable battery or to a super capacitor positioned within the apparatus 900 via the snap-on connector 210 to recharge the rechargeable battery or to recharge the super capacitor via the received electrical energy. Further, the first side 200 of the cover 118 may comprise at least one button 122. The at least one button 122 may be configured to select one or more parameters and display one or more texts or values on the display panel 112. Further, the at least one button 122 is configured to activate or deactivate the display panel 112.

In an alternative embodiment, as shown in FIG. 10A, the apparatus 900 may be installed on the utility meter 1000, example a gas meter. Further, in another alternative embodiment, as shown in FIG. 10B, the apparatus 902 may be installed on the utility meter 1002, example the gas meter. The gas meter is used to measure volume of gas consumed by a residential or commercial building. The gas meter may include the meter body 402, the name plate 404, a set of inlet port 406 and outlet port 408. The gas meter records amount of gas passing through the set of inlet port 406 and outlet port 408 and displays recorded value on the display panel 112. The display panel 112 may be coupled to the gas meter index. In some embodiments, the body 102 of the apparatus 900 may be coupled to the gas meter. The apparatus 100, herein, may be referred as the gas meter index comprising the cover 118, the display panel 112, the set of buttons 114 and optical communication port 116. The cover 118 may be used to accommodate the rechargeable battery. The display panel 112 may indicate gas measurement values and the set of buttons 114 may be configured to set one or more features of the gas meter. Further, the optical communication port 116 may be used to connect the body to the gas meter.

In some embodiments, the cover 118 may be fabricated with at least one hole 124 to couple the cover 118 to at least the front portion 104, the side portion 106, the top portion 108 or the bottom portion 110 of the body 102. In the alternative embodiment shown in FIG. 10A, the at least one solar panel 120 may be coupled to the front portion 104 of the body 102. In an example, the at least one solar panel 120 may be coupled to the front portion of the body, above the cover 118. In another alternative embodiment shown in FIG. 10B, the at least one solar panel 120 may be coupled to the top portion of the body 102. In an example, the at least one solar panel 120 may be coupled to the top portion of the body 102, above the display panel 112. The at least one solar panel 120 may be configured to convert solar energy from sunlight into electrical energy.

In some embodiments, the body 102 may comprise the at least one circuit board 206 electrically coupled to the at least one solar panel 120. The at least one circuit board 206 may be coupled to the at least one solar panel 120 through the at least one cable 208. The at least one circuit board 206 may receive the electrical energy generated by the at least one solar panel 120 through the at least one cable 208. The at least one circuit board 206 may provide the received electrical energy to the apparatus 900 through the at least one cable 208. Further, the at least one circuit board 206 may be electrically coupled to the rechargeable battery or to the super capacitor positioned within the apparatus 900 via the snap-on connector 210 to charge the rechargeable battery or to charge the super capacitor via the received electrical energy. In an example, the at least one solar panel 120 may be used to charge the rechargeable battery or to charge the super capacitor and the rechargeable battery or the super capacitor may be used to power the gas meter. Further, the cover 118 may comprise at least one button 122. The at least one button 122 may be pressed by the user to scroll and select one or more parameters in the form of text or values on the display panel 112.

In some embodiments, a method of assembling of the apparatus 100 is disclosed, in accordance with an example embodiment of the present disclosure. In some embodiments, the apparatus may comprise the body 102 and the cover 118. At first, the cover 118 may be coupled to a portion of the body 102. In some embodiments, the portion may include the front portion 104, the side portion 106, the top portion 108, or the bottom portion 110 of the body 102. In some embodiments, the apparatus 100 may be the gas meter index, and the gas meter index may be installed on a utility meter.

In an example, the apparatus 100 may be an electricity meter index. The electricity meter index may be installed in the electricity meter. The electricity meter index may include the cover 118. The cover 118 may be attached to the front portion 104, the side portion 106, the top portion 108, or the bottom portion 110 of the electricity meter index.

Further, the cover 118 may comprise a recess 204. The recess 204 may be fabricated at a first side 200 of the cover 118. The first side 200 of the cover 118 may be the outer side of the cover 118. The recess 204 may accommodate at least one solar panel 120. The at least one solar panel 120 may be exposed to weather conditions. The at least one solar panel 120 may use the sunlight to convert solar energy from the sunlight into electrical energy.

In an example, the electricity meter may be installed outside a house such that the electricity meter may be exposed to the sunlight. The at least one solar panel 120 may be coupled to the electricity meter index. The at least one solar panel 120 may be accommodated in the recess 204 and exposed to the sunlight directly. The at least one solar panel 120 may use the sunlight to convert solar energy from the sunlight into electrical energy that may be supplied to the electricity meter.

Further, the at least one circuit board 206 may be positioned at a second side 202 (inner side) of the cover 118. The at least one circuit board 206 may be coupled to the at least one solar panel 120 via at least one cable 208. The at least one circuit board 206 may receive the electrical energy from the at least one solar panel 120. The electrical energy may be received by the at least one circuit board 206 through the at least one cable 208. The at least one circuit board 206, through the at least one cable 208, may provide the received electrical energy to the apparatus 100.

In an example, the at least one circuit board 206 may be positioned at a second side 202 (inner side) of the cover 118 of the electricity meter index. The electrical energy may be received by the at least one circuit board 206 through the at least one cable 208. The at least one circuit board 206, through the at least one cable 208, may provide the received electrical energy to the electricity meter. Further, the at least one circuit board 206 may be electrically coupled to a rechargeable battery or to a super capacitor positioned within the electricity meter index. The at least one circuit board 206 may be coupled to the rechargeable battery or to the super capacitor via the snap-on connector 210. The at least one circuit board 206 may recharge the rechargeable battery or the super capacitor via the received electrical energy. The electrical energy generated by the at least one solar panel 120 may be used to charge the rechargeable battery or to charge the super capacitor. The rechargeable battery may be used to power the electricity meter.

Embodiments may be configured to charge the rechargeable battery or to charge the super capacitor of the gas meter index. Embodiments may be configured to charge the rechargeable battery or to charge the super capacitor of the gas meter index in a sustainable manner. Embodiments may allow utilization of sunlight to convert solar energy from sunlight into electrical energy. Embodiments may allow the electrical energy to be stored in the rechargeable battery or in the super capacitor.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
a body;
a cover coupled to a portion of the body, wherein the cover comprising:
a recess fabricated at a first side of the cover, wherein the recess is configured to accommodate at least one solar panel, wherein the at least one solar panel is configured to generate electrical energy; and
at least one circuit board positioned at a second side of the cover and electrically coupled to the at least one solar panel via at least one cable, wherein the at least one circuit board is configured to receive the electrical energy from the at least one solar panel via the at least one cable and provide the received electrical energy to the apparatus.

2. The apparatus of claim 1, wherein the portion corresponds to at least one of a front portion, a side portion, a top portion, or a bottom portion of the body.

3. The apparatus of claim 1, wherein the first side is opposite to the second side of the cover, and wherein the first side of the cover corresponds to an outer side and the second side of the cover corresponds to an inner side.

4. The apparatus of claim 3, wherein the at least one circuit board is configured to be screwed or snap-fitted to the inner side of the cover based at least on depth of the inner side of the cover.

5. The apparatus of claim 1, wherein the at least one solar panel is positioned within the recess via an adhesive, wherein the adhesive is configured to provide ingress protection (IP) to the at least one solar panel.

6. The apparatus of claim 1, wherein the at least one cable is passing from the first side to the second side of the cover via an aperture, and wherein at least one end of the at least one cable is coupled with a snap-on connector, wherein the snap-on connector is configured to electrically connect the at least one solar panel and the at least one circuit board with an electrical source, wherein the cover is detachable from the body and replaceable.

7. The apparatus of claim 6, wherein the at least one circuit board is electrically coupled to a rechargeable battery or to a super capacitor positioned within the apparatus to recharge the rechargeable battery or to recharge the super capacitor via the received electrical energy.

8. The apparatus of claim 1, wherein the first side of the cover is configured to have a tilted surface, wherein the tilted surface is configured to provide solar coverage to the at least one solar panel.

9. The apparatus of claim 1, wherein the at least one circuit board serves as a main circuit board and includes components or circuits such as an LCD, a wireless communication circuit, a rechargeable battery, a supercapacitor and a measurement circuit.

10. The apparatus of claim 1, wherein the first side of the cover comprises at least one button, wherein the at least one button is configured to scroll and select between one or more parameters of readings of the apparatus.

11. A method comprising:
coupling a cover to a portion of a body, wherein the cover comprising:
a recess fabricated at a first side of the cover, wherein the recess is configured to accommodate at least one solar panel, wherein the at least one solar panel is configured to generate electrical energy; and
at least one circuit board positioned at a second side of the cover and electrically coupled to the at least one solar panel via at least one cable, wherein the at least one circuit board is configured to receive the electrical energy from the at least one solar panel via the at least one cable and provide the received electrical energy to the apparatus.

12. The method of claim 11, wherein the portion corresponds to at least one of a front portion, a side portion, a top portion, or a bottom portion of the body.

13. The method of claim 11, wherein the first side is opposite to the second side of the body, and wherein the first side of the cover corresponds to an outer side and the second side of the cover corresponds to an inner side.

14. The method of claim 13 further comprising screwing or snap-fitting the at least one circuit board to the inner side of the cover based at least on depth of the inner side of the cover.

15. The method of claim 11, wherein the at least one solar panel is positioned within the recess via an adhesive, wherein the adhesive is configured to provide ingress protection (IP) to the at least one solar panel.

16. The method of claim 11, wherein the at least one cable is passing from the first side to the second side of the cover via an aperture, and wherein at least one end of the at least one cable is coupled with a snap-on connector, wherein the snap-on connector is configured to electrically connect the at least one solar panel and the at least one circuit board with an electrical source, wherein the cover is detachable from the body and replaceable.

17. The method of claim 16 further comprising coupling electrically the at least one circuit board to a rechargeable battery positioned within the apparatus via the snap-on connector to recharge the rechargeable battery based on the received electrical energy.

18. The method of claim 11, wherein the first side of the cover is configured to have a tilted surface, wherein the tilted surface is configured to provide solar coverage to the at least one solar panel.

19. The method of claim 11, wherein the at least one circuit board serves as a main circuit board and include components or circuits such as an LCD, a wireless communication circuit, a rechargeable battery, a supercapacitor and a measurement circuit.

20. The method of claim 11, wherein the first side of the cover comprises at least one button, wherein the at least one button is configured to scroll and select between one or more parameters of readings of the apparatus.
